(19) United States
(12) Patent Application Publication
(10) Pub. No.: US 2012/0217902 A1
(43) Pub. Date: Aug. 30, 2012

(54) FULL-VOLTAGE AC LED MODULE

(75) Inventor: Ting-Fang Yang, GUISHAN TOWNSHIP (TW)

(73) Assignee: HONGYA LED LIGHTING CO., LTD., GUISHAN TOWNSHIP (TW)

(21) Appl. No.: 13/034,704

(22) Filed: Feb. 25, 2011

(51) Int. Cl. H05B 37/00

(52) U.S. Cl. 315/314

(57) ABSTRACT

A full-voltage AC LED module includes a circuit substrate having a first bridge rectifier circuit comprising a set of first load nodes and a set of first power nodes and a second bridge rectifier circuit comprising a set of second load nodes and a set of second power nodes, and a LED module packaged in the circuit substrate and having a first light-emitting device formed of a series of light-emitting diodes and electrically connected to the set of first load nodes and a second light-emitting device formed of a series of light-emitting diodes and electrically connected to the set of second load nodes. By means of connecting the set of first power nodes and the set of second power nodes in series or in parallel, the required input voltage for starting up the LED module is relatively changed.

### BACKGROUND OF THE INVENTION

1. Field of the Invention:

The present invention relates to LED modules and more particularly, to a full-voltage AC LED module, which can be started with different AC voltages.

2. Description of the Related Art:

LED (light-emitting diode) is a semiconductor photoelectric conversion element. For the advantages of relatively lower power consumption and longer lifespan when compared to conventional incandescent bulb or fluorescent bulb, LED has been intensively used for lighting purpose to substitute for conventional incandescent and fluorescent bulbs.

In many applications, multiple light-emitting diodes may be connected in series and/or in parallel. When starting up light-emitting diodes, a proper voltage level must be provided. When multiple light-emitting diodes are packaged in a circuit substrate in parallel or in series, only the rated voltage can be applied to start up the light-emitting diodes. Therefore, manufacturers must design different circuit substrates and LED modules to fit different application requirements. In consequence, the circuit substrate and LED module design cost is relatively increased.

### SUMMARY OF THE INVENTION

The present invention has been accomplished under the circumstances in view. It is the main object of the present invention to provide a full-voltage AC LED module, which allows change of the input AC voltage required for starting up the LED module by means of connecting the load nodes of two bridge rectifier circuits in series or in parallel.

To achieve this and other objects of the present invention, a full-voltage AC LED module comprises a circuit substrate and a LED module packed in the circuit substrate. The circuit substrate has installed therein a first bridge rectifier circuit comprising a set of first load nodes and a set of first power nodes and a second bridge rectifier circuit comprising a set of second load nodes and a set of second power nodes. The LED module comprises a first light-emitting device formed of a series of light-emitting diodes and electrically connected to the set of first load nodes and a second light-emitting device formed of a series of light-emitting diodes and electrically connected to the set of second load nodes. By means of connecting the set of first power nodes and the set of second power nodes in series or in parallel, the required input voltage for starting up the LED module is relatively changed.

### BRIEF DESCRIPTION OF THE DRAWINGS

FIG. 1 is an elevational view of a full-voltage AC LED module in accordance with a first embodiment of the present invention.

FIG. 2 is a circuit diagram of the full-voltage AC LED module in accordance with the first embodiment of the present invention.

FIG. 3 is an elevational view of a full-voltage AC LED module in accordance with a second embodiment of the present invention.

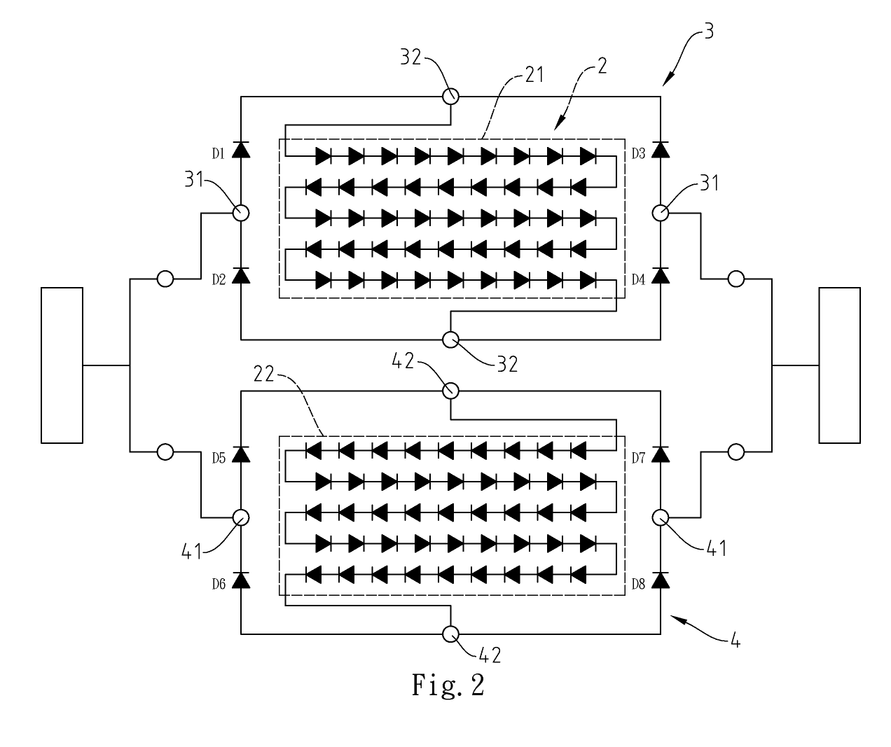

FIG. 2 is a circuit diagram of the full-voltage AC LED module in accordance with the second embodiment of the present invention.

FIG. 5 is an equivalent circuit diagram of the full-voltage AC LED module in accordance with the second embodiment of the present invention.

### DETAILED DESCRIPTION OF THE PREFERRED EMBODIMENT

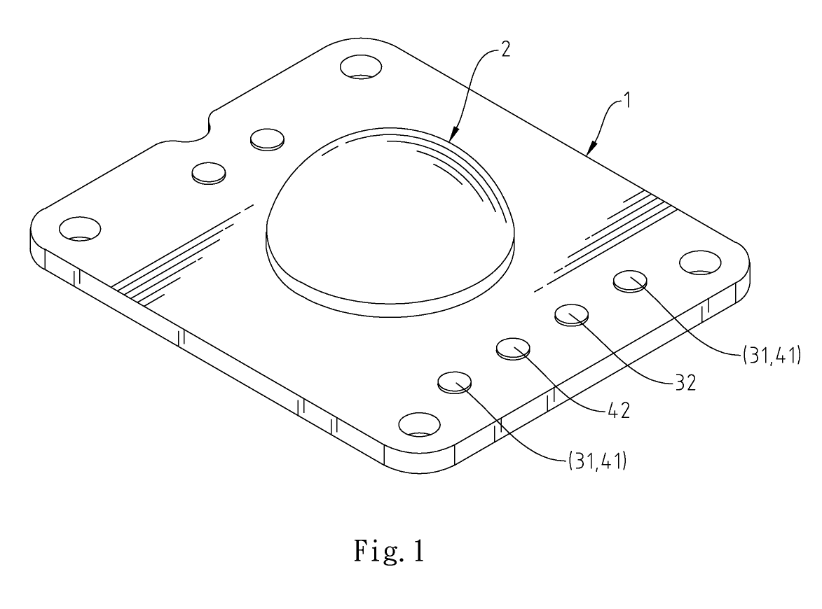

Referring to FIGS. 1 and 2, a full-voltage AC LED module in accordance with a first embodiment of the present invention is shown comprising a circuit substrate 1 and a LED module 2 packaged in the circuit substrate 1.

The circuit substrate 1 has installed therein a first bridge rectifier circuit 3 and a second bridge rectifier circuit 4. The first bridge rectifier circuit 3 comprises four diodes D1˜D4 electrically connected together, wherein diodes D1 and D2 and diodes D3 and D4 are respectively reversely connected such that a set of first load nodes 31 is formed between diodes D1 and D2 and a set of first power nodes 32 is formed between diodes D3 and D4.The second bridge rectifier circuit 4 comprises four diodes D5˜D8 electrically connected together, wherein diodes D5 and D6 and diodes D7 and D8 are respectively reversely connected such that a set of second load nodes 41 is respectively formed between diodes D5 and D6 and between diodes D7 and D8 and a set of second power nodes 42 is respectively formed between diodes D5 and D7 and between diodes D6 and D8. Further, the set of first power nodes 32 and the set of second power nodes 42 are electrically connected in parallel. Further, according to this embodiment, the diodes D1˜D8 are Zener diodes.

The LED module 2 comprises a first light-emitting device 21 formed of a series of light emitting diodes, and a second light-emitting device 22 formed of a series of light emitting diodes. The first light-emitting device 21 is electrically connected to the set of first load nodes 31. The second light-emitting device 22 is electrically connected to the set of second load nodes 41.

When inputting an AC power supply (for example, 110V AC) into the set of first power nodes 32 and the set of second power nodes 42, diodes D1 and D4 are turned on and diodes D2 and D3 are turned off, or, diodes D2 and D3 are turned on and diodes D1 and D4 are turned off during working of the first bridge rectifier circuit 3, so that the polarity of the output voltage of the first light-emitting device 21 is constantly the same and the first light-emitting device 21 can keep working. During working of the second bridge rectifier circuit 4, diodes D5 and D8 are turned on and diodes D6 and D7 are turned off, or, diodes D6 and D7 are turned on and diodes D5 and D8 are turned off so that the polarity of the output voltage of the second light-emitting device 22 is constantly the same and the second light-emitting device 22 can keep working.

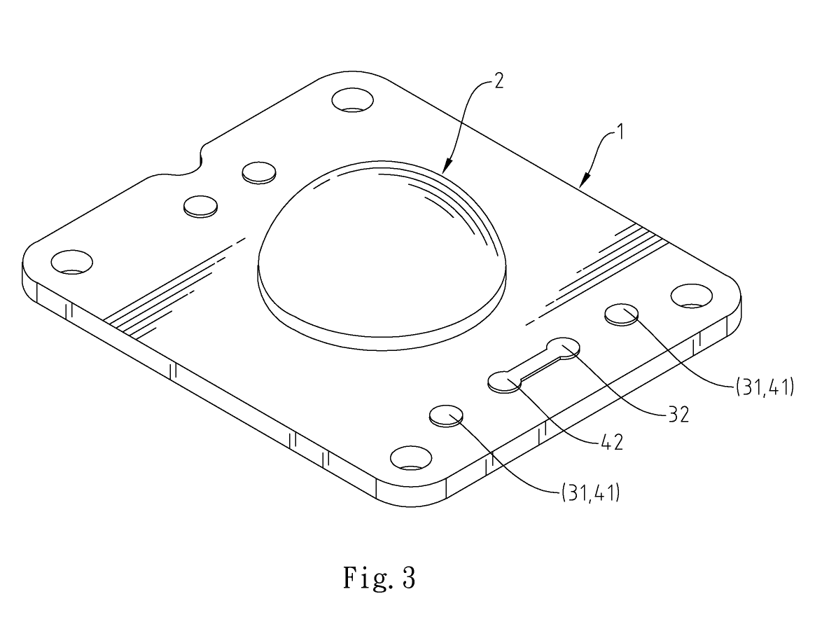

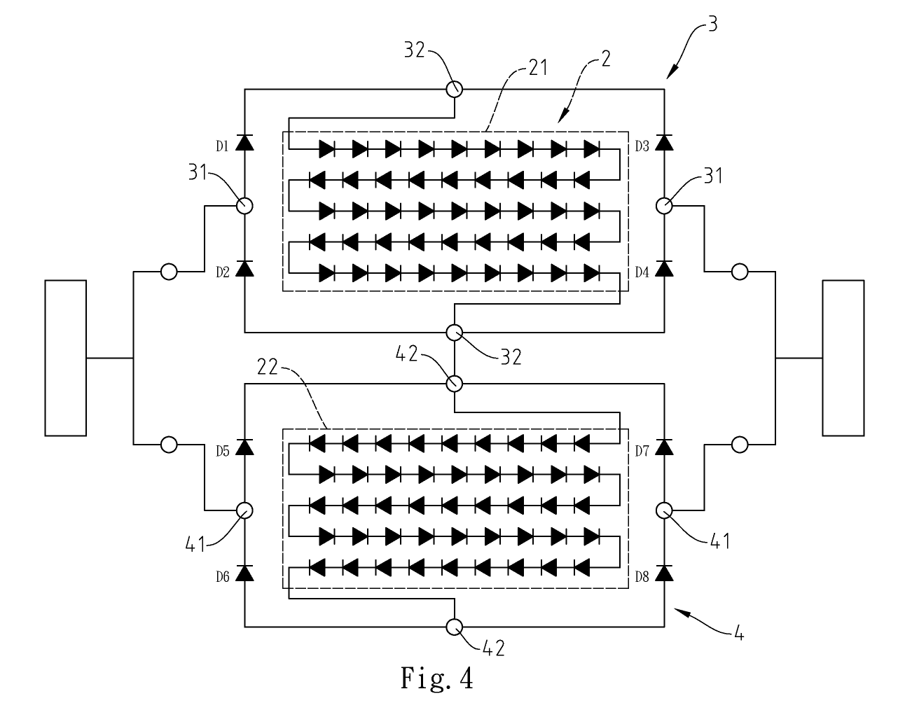

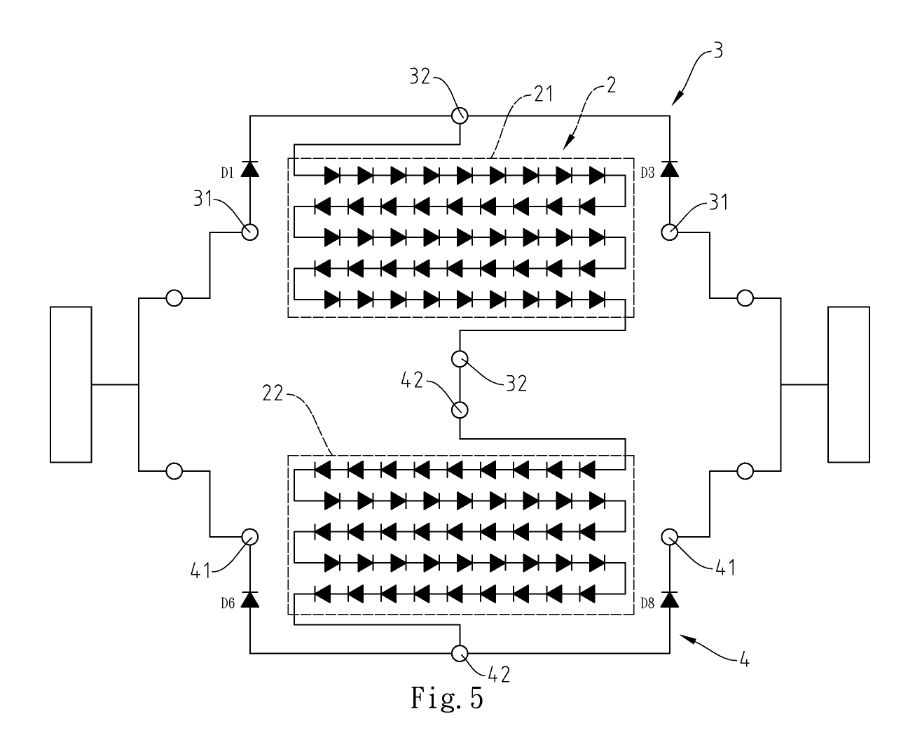

Referring to FIGS. 3-5, when the user is going to input a relatively higher voltage of AC power supply (for example, 220V AC) into the set of first power nodes 32 and the set of second power nodes 42, the user can electrically connect the set of first load nodes 31 and the set of second load nodes 41 in series to let the first light-emitting device 21 and the second light-emitting device 22 be connected in series. At this time, the set of first power nodes 32 and the set of second power nodes 42 are electrically connected in parallel, and the set of first load nodes 31 and the set of second load nodes 41 are electrically connected in series, thus the diodes D2, D4, D5 and D7 are short circuited (see FIG. 5). When AC power supply is inputted into the set of first power nodes 32 and the set of second power nodes 42, diodes D1 and D8 are turned on and diodes D3 and D6 are turned off, or, diodes D3 and D6 are turned on and diodes D1 and D8 are turned off, enabling the polarity of the output voltage of the first light-emitting device 21 and the polarity of the output voltage of the second light-emitting device 22 to be constantly maintained the same, and therefore the first light-emitting device 21 and the second light-emitting device 22 can keep working. Further, because the first light-emitting device 21 and the second light-emitting device 22 are connected in series, the startup voltage required is increased. Therefore, inputting the relatively higher voltage of AC power supply (220V AC) into the set of first power nodes 32 and the set of second power nodes 42 does not cause the first light-emitting device 21 and the second light-emitting device 22 to burn out.

In conclusion, the technical feature of the present invention is the use of the first bridge rectifier circuit 3 and the second bridge rectifier circuit 4 to connect the series of light emitting diodes of the first light-emitting device 21 and the series of light emitting diodes of the second light-emitting device 22 respectively so that the voltage required for starting up the first light-emitting device 21 and the second light-emitting device 22 can be changed by means of connecting the set of first load nodes 31 and the set of second load nodes 41 in series or in parallel. Thus, the LED module 2 in the circuit substrate 1 can be selectively set to consume different voltages of AC power supply.

Although a particular embodiment of the invention has been described in detail for purposes of illustration, various modifications and enhancements may be made without departing from the spirit and scope of the invention.

What the invention claimed is:

1. A full-voltage AC LED module, comprising:
a circuit substrate comprising a first bridge rectifier circuit and a second bridge rectifier circuit first bridge rectifier circuit, said first bridge rectifier circuit comprising a set of first load nodes and a set of first power nodes, said second bridge rectifier circuit comprising a set of second load nodes and a set of second power nodes, said set of first power nodes and said set of second power nodes being electrically connected in parallel; and
a LED module packaged in said circuit substrate, said LED module comprising a first light-emitting device formed of a series of light-emitting diodes and electrically connected to said set of first load nodes and a second light-emitting device formed of a series of light-emitting diodes and electrically connected to said set of second load nodes.

2. A full-voltage AC LED module, comprising:
a circuit substrate comprising a first bridge rectifier circuit and a second bridge rectifier circuit first bridge rectifier circuit, said first bridge rectifier circuit comprising a set of first load nodes and a set of first power nodes, said second bridge rectifier circuit comprising a set of second load nodes and a set of second power nodes, said set of first power nodes and said set of second power nodes being electrically connected in parallel, said set of first power nodes and said set of second power nodes being electrically connected in series; and
a LED module packaged in said circuit substrate, said LED module comprising a first light-emitting device formed of a series of light-emitting diodes and electrically connected to said set of first load nodes and a second light-emitting device formed of a series of light-emitting diodes and electrically connected to said set of second load nodes.
